(19) United States
(12) Patent Application Publication
(10) Pub. No.: US 2008/0028226 A1
(43) Pub. Date: Jan. 31, 2008

(54) System-on-a-chip and method for securely transferring data on a system-on-a-chip

(76) Inventors: Matthew W. Brocker, Chandler, AZ (US); Thomas E. Tkacik, Phoenix, AZ (US); James L. Johnson, Gilbert, AZ (US); Lawrence L. Case, Phoenix, AZ (US)

Correspondence Address: INGRASSIA FISHER & LORENZ, P.C. (FS), 7150 E. CAMELBACK ROAD, SUITE 325, SCOTTSDALE, AZ, 85251, US

(21) Appl. No.: 11/496,872

(22) Filed: Jul. 31, 2006

(51) Int. Cl. H04L 9/00

(52) U.S. Cl. 713/182

(57) ABSTRACT

A system-on-a-chip and method for securely transferring data can include a trusted master; a first trusted slave; an untrusted component; and a common bus coupling the trusted master, the first trusted slave, and the untrusted component, In response to an initiation by a host, the trusted master provides a first access request to request a first data transfer with the first trusted slave, and wherein the trusted master does not perform the first data transfer until authentication of the first trusted slave.

### FIELD OF THE INVENTION

The present invention generally relates to a system-on-a-chip that can securely transfer data and method for securely transferring data on a system-on-a-chip and more specifically relates to a system and method for securely transferring data over a common bus on a system-on-a-chip.

### BACKGROUND OF THE INVENTION

A system-on-a-chip is any type of system that integrates all components of an electrical system on a chip. These are prevalent in the electronic and consumer industries for a wide variety of functions, including functions that require the secure transfer of data. The system-on-a-chip utilizes data protection schemes designed to protect cryptographic keys and secret information on computer platforms. The data protection schemes generally prevent a host from improperly accessing the data. In many conventional systems, this requires that the trusted masters and trusted slaves that are used to transfer the cryptographic keys and secure data must be separated from the rest of the system components and typically requires communication on a secure, private bus. This can result in an inefficient allocation of system resources and additional cost. Other conventional systems may require encryption of secure data during each transfer step within the system.

On the other hand, if a conventional system-on-a-chip attempts to transfer data on a common bus without separating the trusted slaves and the trusted master, security may be compromised. As an example, a host usually initiates a data transfer, for example, a request to download a song. The act of initiating a secure data transfer is not typically a security risk, but the leaking or misdirection of any sensitive data during the transfer is a security risk. Moreover, if sensitive data is moved or copied to an unsecure location, security has been compromised. This is particularly a problem when the requirements of the transfer declare that the contents of the data must remain inaccessible to the host. For example, digital rights management schemes require data to be stored in areas that are sensitive with respect to security and privacy.

What is needed is a method and system-on-a-chip that allows a host to initiate data transfers via hardware such as trusted masters and slaves that can authenticate and securely transfer sensitive data on a common bus with other system components.

### BRIEF DESCRIPTION OF THE DRAWINGS

The present invention will hereinafter be described in conjunction with the following drawing figures, wherein like numerals denote like elements, and wherein:

FIG. 1 illustrates a schematic block diagram of a system-on-a-chip that can securely transferring data on a common bus in accordance with an exemplary embodiment;

FIG. 2 illustrates a more detailed representation of a portion of the system of FIG. 1; and

FIG. 3 illustrates a secure bus signaling protocol according to an exemplary embodiment.

### DETAILED DESCRIPTION OF THE INVENTION

The following detailed description is merely exemplary in nature and is not intended to limit the invention or the application and uses of the invention. Furthermore, there is no intention to be bound by any theory presented in the preceding background of the invention or the following detailed description of the invention.

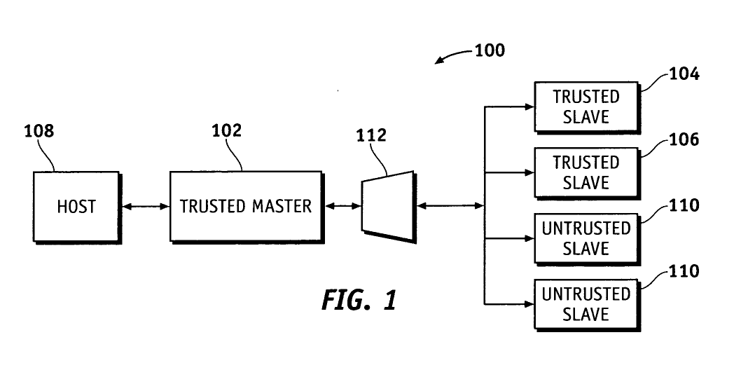

FIG. 1 illustrates an exemplary embodiment of a system-on-a-chip 100 (“SOC,” or simply “system”) in which data can be securely transferred. The system 100 includes a trusted master 102 and at least one trusted slave 104, 106. In the illustrated embodiment, two trusted slaves 104, 106 are shown. The system 100 can also include a host 108, and one or more untrusted slaves 110. The trusted master 102 communicates with the trusted slaves 104, 106 and the untrusted slaves 110 via a common bus 112. Of course, other components can be provided in the system 100. Examples include additional microcontrollers, microprocessors, and DSP cores; additional memory blocks such as RAM, ROM, EEPROM, and Flash; peripherals such as counter-timers, real-time timers, and power-on reset generators; external interfaces such as USB, FireWire, Ethernet, USART, and SPI; analog interfaces such as ADC and DAC; and voltage regulators and power management circuits.

In an exemplary embodiment, the trusted master 102 can receive a request from the host 108 to transfer data between the trusted slaves 104, 106. In the particular exemplary embodiment discussed herein, the proposed data transfer proposes to transfer data from trusted slave 106 to trusted slave 104. Generally, the trusted master 102 can be any hardware device that transfers data in a deliberate, restricted manner. The trusted master 102 can be, for example, direct memory access (DMA). The trusted slaves 104, 106 can be any hardware device that responds to data or control requests, and performs a security function.

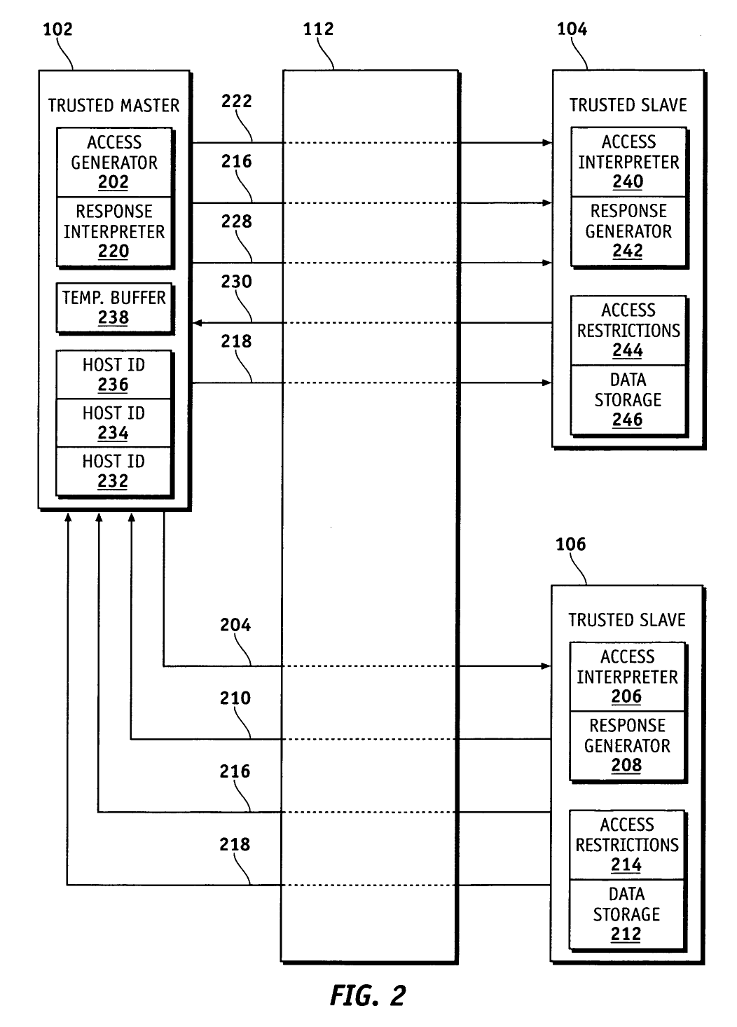

FIG. 2 illustrates the elements of the trusted master 102, trusted slave 104, and trusted slave 106 in greater detail and in accordance with an exemplary embodiment. FIG. 2 also illustrates at least some of the exemplary communications between the trusted master 102, trusted slave 104, and trusted slave 106.

The trusted master 102 can include an access generator 202 that receives information from the host 108 concerning the proposed data transfer. The information received by the trusted master 102 can include a host request 232, pointers 234, and the host ID 236. The pointers 234 can include address information for the data transfer.

In response to the request 232 from the host 108, the access generator 202 of the trusted master 102 provides an access request 204 to the trusted slave 102. The access generator 202 can include a configured or hard coded list of access requests to provide to the trusted slaves 104, 106. The access request 204 can include the bus credentials or ID of the trusted master 102, the address of the data within the trusted slave 106, and a request for authentication from the trusted slave 106. The access request 204 can be based upon the identities of the host 108 and trusted master 102 and the requested operation. Generally, the ID's provided by the host 108, the trusted master 102, and the trusted slaves 104, 106 can be any type of secure identifier.

The trusted slave 106 includes an access interpreter 206 that receives the access request 204. The trusted slave 106 also includes a response generator 208 that generates a response 210 to the access request 204. The response generator 208 can have a list that provides appropriate responses to the particular access request 204 from the trusted master 102. The response 210 can include either a denial or an acceptance of the access request 204 from the trusted master 102. An acceptance in the response 210 also acts as authentication for the trusted slave 102. The authenticating response 210 may be, for example, a single bit indicating that the trusted slave 106 is trusted, or any other kind of trust identifier.

In this embodiment, the data to be accessed in the trusted slave 106 is stored in data storage 212. Since the slave 106 is a trusted slave 106, the trusted slave 106 also includes access restrictions 214 for the data storage 212. The data may include tags having information concerning data restrictions on the data to be transferred. The data restrictions 216 can be provided to the trusted master 102. The data restrictions 216 can be dependent on, for example, the credentials of the trusted master 102, and ensure that the trusted master 102 directs the data to an appropriate location. The data restrictions 216 can include restrictions such as read, write, and/or execute-only, as well as the particular trusted masters that can have access to the data; the acceptable locations for storage; and the functions that can have access to the data. For example, the data restrictions 216 can be so restrictive as to require that only one location in the entire chip can also have access to this data and require that it must be put there by specific trusted master.

Generally, the request 204 provided by the trusted master 102, and the response 210 provided by the trusted slave 106, as well as the security restrictions 216 on the data 218, can be very general or very specific. In effect, the data restrictions 216 can become bound to the data 218.

A response interpreter 220 in the trusted master 102 receives and interprets the response 220 from the response generator 208 in the trusted slave 106. Generally, the response interpreter 220 has a list of accepted trusted slave responses. The response interpreter 220 confirms that the trusted slave 106 is authentic, and can additionally consider the data restrictions 216 on the data within the trusted slave 106. If the response interpreter 220 indicates that the trusted slave 106 is authentic and the data restrictions 216 are acceptable, the trusted master 102 will read the data 218 from the trusted slave 106. The trusted master 102 does not read the data 218 until the trusted slave 106 authenticates itself. Moreover, due to tags on the data 218, the trusted master 102 does not need to rely on a memory map. The trusted master 102 can have a temporary buffer 238 to hold the data 218 while it authenticates the trusted slave 104 to which the data 218 is to be transferred. The buffer 238 may be automatically cleared after each data transfer and can be an allocated slave memory with dynamic access privileges.

Next, the access generator 202 of the trusted master 102 can provide an access request 222 to the trusted slave 104. The access request 222 from the trusted master can also include the proposed write address information. The access generator 202 can further provide information related to the data restrictions 216 to the trusted slave 204. The trusted master 102 may also provide place holder data 228 to the trusted slave 204. The trusted slave 104 can include an access interpreter 240 to receive and interpret the access request 222 and the data restrictions 216. The trusted slave 104 can further include a response generator 242 that provides a response 230 that authenticates the trusted slave 104 to the trusted master 102. The trusted master 102 can now write the sensitive data 218 to the trusted slave 104. The trusted slave 104 can store the data 218 in data storage 242 with access restrictions 244. Once the data 218 transfer is complete, the trusted master 102 can provide a done signal to the host 108. If the host 108 had attempted to request the secret keys directly from the trusted slaves 104, 106, access would have been denied, or if the host 108 had requested that the trusted master 102 write the data to an unsecure location, the request would have been similarly denied.

The exemplary embodiment provides a system and method for binding data restrictions 216 to the data 218, transporting data 218 securely with its restrictions 216 across a common bus 112, and handling the data 218 once it is transferred. Once data 218 is bound to its restrictions 216, the data 218 becomes encapsulated by a network of hardware, for example trusted master 102 and trusted slaves 104, 106, and inaccessible to the host 108. The data 218 and the associated restrictions 216 can vary based on function and location.

Thus, although software in the host 108 initiates the data transfer, the trusted master 102 determines the permissions of the locations in the trusted slaves 104, 106 that it is accessing at the time it is accessing it. The responses 210, 230 and requests 204, 222 provided by the trusted master 102 and the trusted slaves 104, 106 are hardware-based identifiers that can not be masqueraded, and as such, provide for a secure transfer of the data 218. The system 100 prevents the trusted master 102 from placing the secure data in an unauthorized location, for example, one of the untrusted slaves 110.

Additional features can be provided to the trusted master 102 and trusted slaves 104, 106. For example, one such feature of the trusted slaves 104, 106 can be automatic zeroization on allocation. Particularly, if data restrictions 216 are changed or otherwise manipulated, then the data 218 is automatically zeroized on the location where the permissions change. However, the system 100 may allow more restrictive changes on data.

Each trusted slave 104, 106 can be a temporal device such as a timer, a process and function intensive device such as an encryption engine, or a static device such as a RAM or flash memory, or any variation thereof. Each of type of trusted slave has its own inherent restrictions and capabilities that can be considered when developing the secure response codes. For example, an encryption engine might hold several different types of data simultaneously, such as keys, content, and encrypted data. The encrypted data may be public while the keys may be highly confidential. Also, each key location may have unique functional restrictions. The encryption engine may or may not need to cater to several owners simultaneously. A trusted slave RAM may have several owners of data and must maintain separation. A trusted slave may have the ability to wait on the bus, if requested by the trusted master, to allow the trusted master to authenticate the trusted slave before writing data to it.

One exemplary embodiment and exemplary use of the present invention includes provisioning a key in a secure environment. Using FIG. 1 as a reference, in this embodiment, the host 108 requests access to data within the secure memory of a trusted slave 106, but the host 108 should not have access to the key necessary to decrypt the data. The trusted master 102 and the trusted slaves 104, 106 are on the same bus 112 with other unsecure components 110. In this example, the trusted master 102 has at least two different commands that can be provided by the host 108. The host 108 can instruct the trusted master 102 to decrypt the key and to decrypt the data.

In this example, the host 108 instructs the trusted master 102 to decrypt the key. The trusted master 108 requests the key from the trusted slave 106. The trusted slave 106 provides the key to the trusted master 102 and instructs the trusted master 102 that the host 108 should not have access to the key. The trusted master 102 decrypts the key, and requests access to the trusted slave 106 to write the output of decryption back into the trusted slave 106. In response to the trusted master 102 access request, the trusted slave 106 provides a response signal. If the response signal is appropriate, the trusted master 102 will write the decrypted key to the trusted slave 106. If the response had not been appropriate, it would have indicated to the trusted master 102 that the host 108 had attempted to request that the trusted master 102 place the decrypted key in an unsecure location, and the trusted master would not have complied with the requested.

Next, the host 108 requests that the trusted master 102 utilize the decrypted key to decrypt data. The trusted master 102 requests access to the decrypted key from the trusted slave 106, and assuming that the trusted slave 106 provides the proper response, the trusted master 102 reads the decrypted key from the trusted slave 106. The trusted master 102 then requests access to the encrypted data in the trusted slave 106. Again, assuming that the trusted master 102 receives the proper response, the trusted master 102 utilizes a data decryption command to decrypt the data. To write the data to another trusted slave 104, the trusted master 102 again requests access, and assuming that the trusted slave 104 provides the appropriate secure response, the trusted master 102 writes the decrypted data to the trusted slave 104. If the trusted slave 104 had not provided the appropriate security response, the trusted master 102 would have aborted the command by the host 108. Or, if the host 108 had told the trusted master 102 to read the key from another location, the trusted slave 104 would not have responded correctly, and the trusted master 102 would have similarly aborted the command.

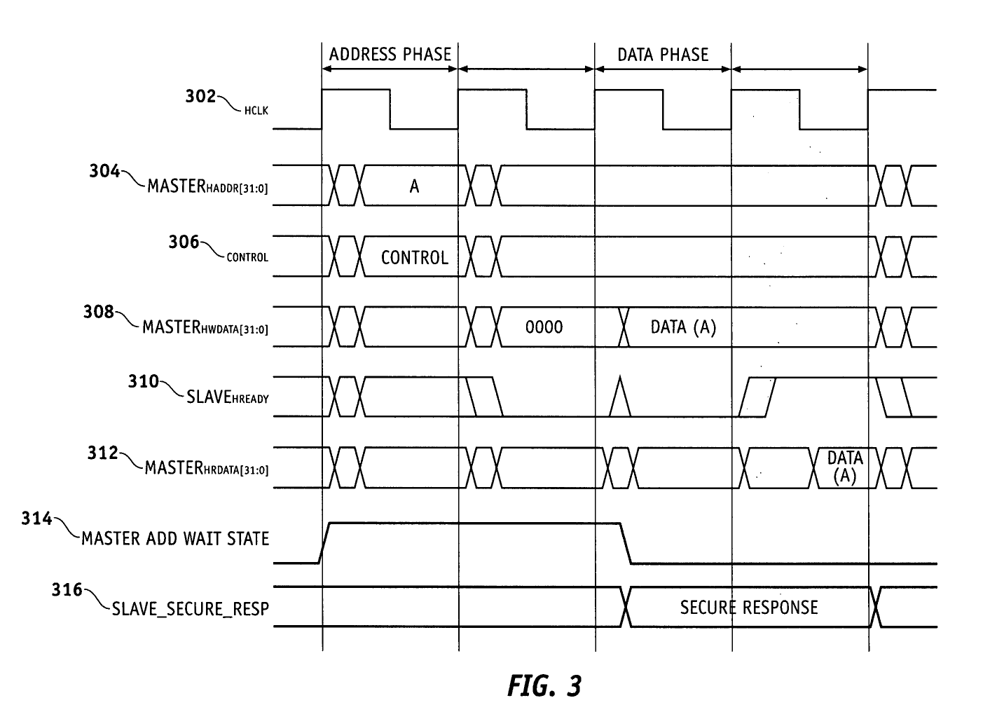

FIG. 3 illustrates the secure bus signaling protocol 300 for the trusted master and trusted slave according to one embodiment. The transaction depicted by the illustrated waveform is an example of an “atomic” secure bus write transaction because the slave is authenticated and written to within the same bus transaction. In this exemplary embodiment, because the trusted master is not operating in a completely trusted environment, it can not be sure that data it is writing will be properly ignored by the untrusted components. As a result, the trusted master sends out bus request commencement control signals 306 to the slave. The control signals 306 correspond to the identifiers used for determining the type of access requested and the identification of the requesting component, such as Host ID and Trusted Master ID. In the illustrated embodiment, the HCLK signals 302 correspond to the clock of the system. The signals labeled Master HADDR 304 correspond to the address being generated from the trusted master to the trusted slave. If the slave is trusted, the trusted slave will respond appropriately to the signals from the trusted master and perhaps provide additional information about the slave and associated secure location. The trusted master can begin the transaction with bogus data signals, and when the master receives an appropriate Secure Response, labeled Slave_Secure_Resp 316, the master switches the bus to writes the sensitive data, labeled Master HWDATA 308. The Master HWDATA signals 308 are used when the trusted master is performing a write transaction on the bus. In other words, once the trusted master receives the secure response, the trusted master stores the data in the secure location. The trusted slave may also reject the transfer if the control signals 306 given by the master are not appropriate, even if the master itself is considered trustworthy. The slave has added wait states and then accepts the data on the next clock cycle. The slave acknowledges the transaction with Slave HREADY signals 310 that are asserted when the sensitive data is accepted. The Slave HREADY signals 310 correspond to the acknowledgement from the slave. The Master HRDATA signals 312 are used when the master is performing a read transaction on the bus. The Master Add Wait State signals 314 provide a way to add cycles dynamically if needed to receive a secure response and maintain control of the bus atomically. The slave is configured to add a wait state as necessitated by the master. Of course, other signaling protocols are possible in other exemplary embodiment of the present invention.

An exemplary embodiment can further include host initiated permission binding in which the software has a software-bound (L1) transaction. In this case, the host ID can be locked into the security request information so that all transfers must provide the host ID as the primary master. Data that is owned by another host with restrictions that prohibit the transferring host ID will be blocked. This technique can be used when the trusted master must act as a delegate of the transfer initiator.

Another exemplary embodiment can further include security-by-location. Most computer processors rely on an MMU to separate user data. The data is separated by pages in the size of 1 KB, 2 KB, or 4 KBs. If the trusted master receives instructions to process data that comes from the same location as the data itself, then there is a security-by-location implication because both pieces of information belong to the same user. So, for example, a trusted master can provide protection in the case where it reads the instructions and data from the same page in a trusted slave, sends the data and keys to a processing trusted slave such as an encryption engine, and then writes the resulting data back to a location in the same place in the trusted slave. The trusted slave does not need to consider all the access permissions and responses. It will only need to determine that the trusted slave is completely within the boundary; that the trusted slave location does not change ownership, for example by a lock-unlock mechanism; that the processing trusted slave does not allow access by others when operating; and clears all data after processing. Accordingly, this technique is a simple way to take advantage of the MMU without having one in the trusted master itself.

In another exemplary embodiment, the system can further include Lock-Unlock functionality, particularly in advanced systems. Software-only security information may be unknown to the hardware, and the data permissions when written may need to provide this restriction.

The system and method can be simpler to implement and faster and/or smaller than current alternatives such as encrypting internal data or placing MMUs on DMAs, particularly on small commercial chips.

Accordingly, exemplary embodiments of the present invention enable a secure transfer of data on an otherwise unsecure bus. The trusted masters and trusted slaves can be particularly configured to provide the appropriate requests and responses to ensure the security of the data without being separated from the remaining components on the common bus. The signals to and from the trusted master and slaves can be otherwise ignored by the other components. Various embodiments also provide a secure data transfer without requiring encryption over the common bus.

In summary, a system for securely transferring data comprises a trusted master; a first trusted slave; an untrusted component; and a common bus coupling the trusted master, the first trusted slave, and the untrusted component. In response to an initiation by a host, the trusted master provides a first access request to request a first data transfer with the first trusted slave, and the trusted master does not perform the first data transfer until authentication of the first trusted slave.

In various embodiments, the first data transfer can include writing and/or reading the data to the first trusted slave. The first trusted slave can be configured to provide an authentication signal to the trusted master. The system can further comprise a second trusted slave coupled to the trusted master by the common bus. In response to the initiation by the host, the trusted master provides a second access request to request a second data transfer with the second trusted slave, and the trusted master does not perform the second data transfer until authentication of the second trusted slave. In this embodiment, the first data transfer can include reading the data in the first trusted slave, and the second data transfer can include writing the data to the second trusted slave. The first trusted slave can provide data restrictions for the data. The trusted master can provide a trusted master ID to the first trusted slave. The first trusted master can include an access generator for generating the first access request and a response interpreter for interpreting the authentication. The first trusted slave can include an access interpreter for interpreting the first access request and a response generator for generating the authentication. The trusted master can include a buffer for temporarily storing the data during the first data transfer.

In one embodiment, a method is provided for securely transferring data in a system comprising a trusted master, a first trusted slave, an untrusted component, and a common bus coupling the trusted master, the first trusted slave, and the untrusted component. The method comprises receiving an initiation from a host; generating a first access request by the trusted master to request a first data transfer with the first trusted slave; authenticating the first trusted slave; and performing the first data transfer after authenticating the first trusted slave.

In various embodiments, the first data transfer of the method can include writing and/or reading the data to the first trusted slave. The authenticating step can include receiving an authentication signal from the first trusted slave. The method can further include generating a second access request by the trusted master to request a second data transfer with a second trusted slave; authenticating the second trusted slave; and performing the second data transfer after authenticating the second trusted slave. The first data transfer of the method can include reading the data in the first trusted slave, and the second data transfer can include writing the data to the second trusted slave. The first trusted slave of the method can provide data restrictions for the data. The trusted master of the method can provide a trusted master ID to the first trusted slave. The first trusted master of the method can include an access generator for generating the first access request and a response interpreter for interpreting the authentication. The first trusted slave of the method can include an access interpreter for interpreting the first access request and a response generator for generating the authentication. The trusted master of the method can include a buffer for temporarily storing the data during the first data transfer.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A system-on-a-chip (SOC) for securely transferring data, comprising:
a trusted master;
a first trusted slave;
an untrusted component; and
a common bus coupling the trusted master, the first trusted slave, and the untrusted component,
wherein, in response to an initiation by a host, the trusted master provides a first access request to request a first data transfer with the first trusted slave, and wherein the trusted master does not perform the first data transfer until authentication of the first trusted slave.

2. The SOC of claim 1, wherein the first data transfer includes at least one of
writing the data to the first trusted slave, and
reading the data in the first trusted slave.

3. The SOC of claim 1, wherein first trusted slave is configured to provide an authentication signal to the trusted master.

4. The SOC of claim 1, further comprising a second trusted slave coupled to the trusted master by the common bus,
wherein, in response to the initiation by the host, the trusted master provides a second access request to request a second data transfer with the second trusted slave, and wherein the trusted master does not perform the second data transfer until authentication of the second trusted slave.

5. The SOC of claim 4, wherein the first data transfer includes reading the data in the first trusted slave, and the second data transfer includes writing the data to the second trusted slave.

6. The SOC of claim 1, wherein the first trusted slave provides data restrictions for the data.

7. The SOC of claim 1, wherein the trusted master provides a trusted master ID to the first trusted slave.

8. The SOC of claim 1, wherein the first trusted master includes an access generator for generating the first access request and a response interpreter for interpreting the authentication.

9. The SOC of claim 1, wherein the first trusted slave includes an access interpreter for interpreting the first access request and a response generator for generating the authentication.

10. The SOC of claim 1, wherein the trusted master includes a buffer for temporarily storing the data during the first data transfer.

11. A method for securely transferring data in a system-on-a-chip comprising a trusted master, a first trusted slave, an untrusted component, and a common bus coupling the trusted master, the first trusted slave, and the untrusted component, the method comprising:
receiving an initiation from a host;
generating a first access request by the trusted master to request a first data transfer with the first trusted slave;
authenticating the first trusted slave; and
performing the first data transfer after authenticating the first trusted slave.

12. The method of claim 11, wherein the first data transfer includes at least one of
writing the data to the first trusted slave, and
reading the data in the first trusted slave.

13. The method of claim 11, wherein the authenticating step includes receiving an authentication signal from the first trusted slave.

14. The method of claim 11, wherein the system further comprises a second trusted slave coupled to the trusted master by the common bus, and wherein the method further comprises:
generating a second access request by the trusted master to request a second data transfer with a second trusted slave;
authenticating the second trusted slave; and
performing the second data transfer after authenticating the second trusted slave.

15. The method of claim 14, wherein the performing the first data transfer step includes reading the data in the first trusted slave, and the performing the second data transfer step includes writing the data to the second trusted slave.

16. The method of claim 11, further comprising receiving data restrictions for the data from the first trusted slave.

17. The method of claim 11, further comprising providing a trusted master ID to the first trusted slave.

18. The method of claim 11, wherein the first trusted master includes an access generator for generating the first access request and a response interpreter for interpreting the authentication.

19. The method of claim 11, wherein the first trusted slave includes an access interpreter for interpreting the first access request and a response generator for generating the authentication.

20. The method of claim 11, wherein the trusted master includes a buffer for temporarily storing the data during the first data transfer.
